(19) United States
(12) Patent Application Publication
(10) Pub. No.: US 2017/0154460 A1
(43) Pub. Date: Jun. 1, 2017

(54) VIEWING FRUSTUM CULLING METHOD AND DEVICE BASED ON VIRTUAL REALITY EQUIPMENT

(71) Applicants: Le Holdings (Beijing) Co., Ltd., Beijing (CN); LE SHI ZHI XIN ELECTRONIC TECHNOLOGY (TIANJIN) LIMITED, Beijing (CN)

(72) Inventor: Xuelian Hu, Beijing (CN)

(21) Appl. No.: 15/242,522

(22) Filed: Aug. 20, 2016

Related U.S. Application Data
(63) Continuation-in-part of application No. PCT/CN2016/082511, filed on May 18, 2016.

(30) Foreign Application Priority Data
Nov. 26, 2015 (CN) 2015108449795

(51) Int. Cl. G06T 15/30; G06T 19/20; G06T 19/00; G06F 3/01; G06T 15/20

(52) U.S. Cl. CPC G06T 15/30; G06F 3/012; G06T 15/20; G06T 19/006; G06T 19/20

(57) ABSTRACT

The embodiments of the disclosure provide a method and device of viewing frustum culling and a display method based on virtual reality equipment and the virtual reality equipment. The method of viewing frustum culling comprises: determining a first field angle of the left eye and a second field angle of the right eye of a human body; acquiring a union area of the first field angle and the second field angle as a viewing frustum of the human body; and culling a geometry in a current 3D scene to be presented according to the viewing frustum. By adopting the viewing frustum culling method and device and the display method based on virtual reality equipment and the virtual reality equipment, the calculation quantity in the viewing frustum culling process is effectively reduced, the rendering efficiency is improved, and the rendering delay caused by adopting traditional viewing frustum culling is reduced.

### CROSS-REFERENCE TO RELATED APPLICATIONS

The present invention claims priority to PCT International Patent Application No. PCT/CN2016/082511 filed on May 18, 2016, which claims priority to the Chinese Application No. 201510844979.5, filed on Nov. 26, 2015, and entitled “IMAGE PROCESSING METHOD AND APPARATUS” the entirety of each of which is incorporated by reference.

### FIELD OF TECHNOLOGY

The embodiments of the present disclosure relate to the field of computer graphics technology, and particularly relate to a method and device of viewing frustum culling and a display method based on virtual reality equipment and the virtual reality equipment.

### BACKGROUND

The virtual reality (VR) technology involves a computer simulation system capable of creating and experiencing a virtual world. VR generates a simulation environment with a computer, wherein the simulation environment is an interactive 3D scenes of multi-source information fusion and a system simulation of entity behaviors, and enables a user to be immersed therein.

The viewing frustum indicates a visible frustum range of a camera in a scene. Due to perspective transformation, the viewing frustum applied to a computer is a quadrangular frustum observation pyramid, and is encircled by six planes including top, bottom, left, right, front and back. Objects within the viewing frustum are visible, otherwise, objects are invisible. When human eyes observe a scene, the objects beyond the viewing frustum are invisible, so the invisible scene can be removed before displaying and scene rendering is not influenced. Thus, in the scene rendering process, all vertex data within the viewing frustum are visible, whereas the scene data beyond the viewing frustum are invisible. Viewing frustum culling is to remove the invisible scene data before the vertex data are sent to a rendering pipeline.

In the present mobile phone-based virtual reality (VR) scheme, viewing frustum culling of virtual reality equipment is realized on a 3D scene according to field angles of left and right eyes calculated on the basis of head motion.

However, the inventor discovers that the prior art at least has the following problems during implementation:

In the prior art, the field angles of left and right eyes need to be calculated according to head motion and are adopted for viewing frustum culling of a 3D scene respectively, then two times of culling calculation is needed, and the culling is thus complex; and when the geometry after two times of viewing frustum culling is rendered, the rendering is delayed, and then display delay is caused.

### SUMMARY

The embodiments of the present disclosure provide a method of viewing frustum culling and device and a display method based on virtual reality equipment and the virtual reality equipment, for solving the problem of delay caused by two times of culling calculation in the viewing frustum culling process of a 3D scene in the prior art, and quick and convenient culling of the VR 3D scene can be realized.

The embodiments of the present disclosure provide a method of viewing frustum culling based on virtual reality equipment, including:

determining a first field angle of the left eye and a second field angle of the right eye of a human body;

acquiring a union area of the first field angle and the second field angle as a viewing frustum of the human body; and

culling a geometry to be presented in a current 3D scene according to the viewing frustum.

The embodiments of the present disclosure provide a display method based on virtual reality equipment, including:

acquiring the geometry culled by the above method of viewing frustum culling based on virtual reality equipment to be presented in the 3D scene;

rendering and drawing the culled geometry to be presented in the 3D scene; and

displaying the rendered and drawn geometry to be presented in the 3D scene.

The embodiments of the present disclosure provide a viewing frustum culling device based on virtual reality equipment, including:

a determination module, used for determining a first field angle of the left eye and a second field angle of the right eye of a human body;

an acquisition module, used for acquiring a union area of the first field angle and the second field angle as a viewing frustum of the human body; and

a processing module, used for culling a geometry in a current 3D scene to be presented according to the viewing frustum.

The embodiments of the present disclosure provide virtual reality equipment, including an acquisition unit, a rendering unit, a display unit and the above viewing frustum culling device based on virtual reality equipment;

the acquisition unit is used for acquiring the geometry culled by the above viewing frustum culling device based on virtual reality equipment to be presented in the 3D scene;

the rendering unit is used for rendering and drawing the culled geometry acquired by the acquisition unit to be presented in the 3D scene; and

the display unit is used for displaying the geometry rendered and drawn by the rendering unit to be presented in the 3D scene.

The embodiments of the present disclosure provide virtual reality equipment, including:

a processor, a memory, a communication interface and a bus; wherein,

the processor, the memory and the communication interface communicate with each other by the bus;

the communication interface is used for completing the information transmission of the virtual reality equipment and a server;

the processor is used for invoking a logic instruction in the memory to execute the following method:

determining a first field angle of the left eye and a second field angle of the right eye of a human body; acquiring a union area of the first field angle and the second field angle as a viewing frustum of the human body; culling a geometry to be presented in a current 3D scene according to the viewing frustum; rendering and drawing the culled geometry to be presented in the 3D scene; and displaying the rendered and drawn geometry to be presented in the 3D scene.

The embodiments of the present disclosure further provide a computer program, including a program code, wherein the program code is used for executing the following operations:

determining a first field angle of the left eye and a second field angle of the right eye of a human body;

acquiring a union area of the first field angle and the second field angle as a viewing frustum of the human body; and

culling a geometry to be presented in a current 3D scene according to the viewing frustum.

rendering and drawing the culled geometry to be presented in the 3D scene; and

displaying the rendered and drawn geometry to be presented in the 3D scene.

The embodiments of the present disclosure provide a storage medium, used for storing the above computer program.

According to the method of viewing frustum culling and device and the display method based on virtual reality equipment and the virtual reality equipment provided by the embodiments of the present disclosure, the union area of the field angles of left and right eyes of a human body is used as a real viewing frustum of the human body, and viewing frustum culling is performed according to the real viewing frustum, so that the data volume for drawing a geometry is greatly reduced, then the calculation quantity in the viewing frustum culling process is reduced, the rendering efficiency is improved, and the rendering delay caused by adopting traditional viewing frustum culling is reduced.

### BRIEF DESCRIPTION OF THE DRAWINGS

To illustrate the technical solutions in the embodiments of the present disclosure or in the prior art more clearly, a brief introduction on the accompanying drawings which are needed in the description of the embodiments or the prior art is given below. Apparently, the accompanying drawings in the description below are merely some of the embodiments of the present disclosure, based on which other drawings can be obtained by the persons of ordinary skill in the art without any creative effort.

FIG. 1 is a flow chart of a method of viewing frustum culling based on virtual reality equipment according to some embodiments of the present disclosure;

FIG. 2 is a flow chart of a display method based on virtual reality equipment according to some embodiments of the present disclosure;

FIG. 3 is a block diagram of a viewing frustum culling device based on virtual reality equipment according to some embodiments of the present disclosure;

FIG. 4 is a block diagram of virtual reality equipment according to some embodiments of the present disclosure.

FIG. 5 is a schematic diagram of a solid structure of virtual reality equipment.

### DESCRIPTION

To make the objectives, technical solutions and advantages of the embodiments of the present disclosure clearer, a clear and complete description of the technical solutions in the embodiments of the present disclosure will be given below, in combination with the accompanying drawings in the embodiments of the present disclosure. Apparently, the described embodiments are a part, but not all, of the embodiments of the present disclosure. All of other embodiments, obtained by those of ordinary skill in the art based on the embodiments of the present disclosure without any inventive efforts, fall into the protection scope of the present disclosure.

It could be appreciated by those skilled in the art that the singular forms “one”, “one piece of”, “said” and “the” used herein may also have plural forms unless specified. It should be further appreciated that the expression “include” used in the specification of the present disclosure indicates existing features, integers, steps, operations, elements and/or assemblies, but does not exclude one or more other features, integers, steps, operations, elements, assemblies and/or combinations thereof which exist or are added.

It could be appreciated by those skilled in the art that all terms (including technical terms and scientific terms) used herein have the same meanings as common understanding of those of ordinary skill in the art unless additionally defined. It should be further appreciated that the terms defined in universal dictionaries should be understood as having the meanings in accordance with those in contexts of the prior art, and should not be interpreted by idealized or over formal meanings unless specifically defined.

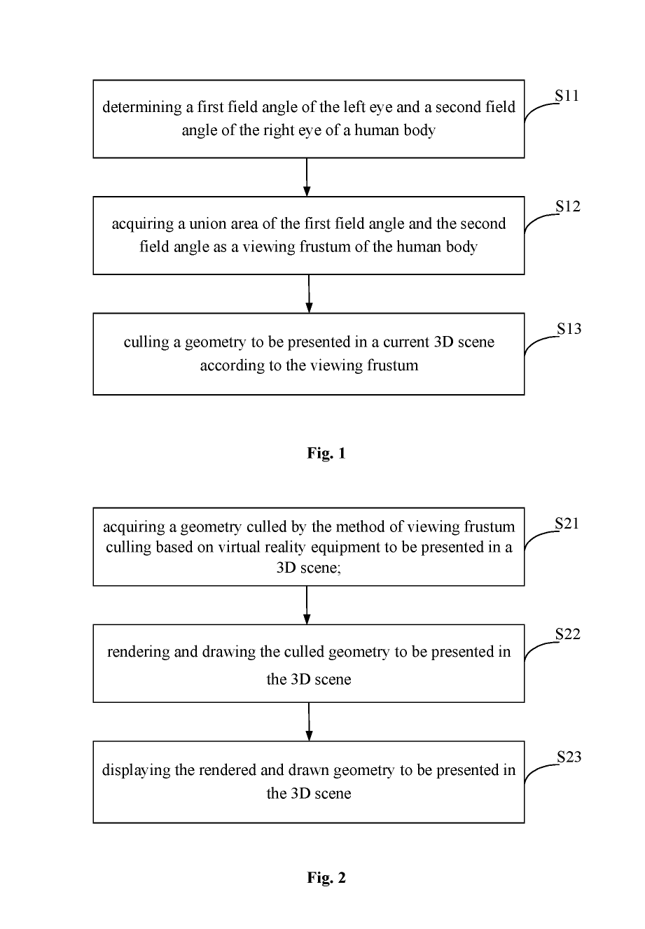

FIG. 1 shows a flow chart of a method of viewing frustum culling based on virtual reality equipment according to some embodiments of the present disclosure.

With reference to FIG. 1, the method of viewing frustum culling based on virtual reality equipment, according to some embodiments of the present disclosure, includes the following steps.

S11: determining a first field angle of the left eye and a second field angle of the right eye of a human body.

In practical application, when the virtual reality equipment is adopted for VR experience, the field angles of human left and right eyes are different, so in order to realize viewing frustum culling of a VR 3D scene, the first field angle of the left eye and the second field angle of the right eye of the human body should be obtained in advance.

It should be noted that the virtual reality equipment according to some embodiments is an intelligent equipment with a virtual reality function, e.g., a VR helmet, VR glasses, etc., and the present disclosure is not limited thereto.

S12: acquiring a union area of the first field angle and the second field angle as a viewing frustum of the human body.

Particularly, a union is solved from the two field angles of the left and right eyes according to the first field angle of the left eye and the second field angle of the right eye of the human body determined in the step S11, and the obtained union area is a combined part of visible areas of the left and right eyes, so the obtained union area can be used as a real viewing frustum of the human body.

S13: culling a geometry to be presented in a current 3D scene according to the viewing frustum.

In this step, the geometry to be presented in the current 3D scene in the virtual reality equipment is culled according to the obtained real viewing frustum of the human body, so that the problem of delay caused by two times of culling calculation according to the viewing frustum of the left and right eyes in the viewing frustum culling process of the 3D scene in the prior art is solved, and the VR3D scene is quickly and conveniently culled.

In some embodiments of the present disclosure, the union area of the field angles of human left and right eyes is used as a real viewing frustum of the human body, and viewing frustum culling is performed according to the real viewing frustum, so that the data volume for drawing a geometry is greatly reduced, then the calculation quantity in the viewing frustum culling process is reduced, the rendering efficiency is improved, and the rendering delay caused by adopting traditional viewing frustum culling is reduced.

Further, step S11 of determining a first field angle of the left eye and a second field angle of the right eye of a human body includes the following steps not shown in the figure:

S111: acquiring spatial state information of the head of the human body and system setting parameters of the current virtual reality equipment.

Particularly, acquiring spatial state information of the head of the human body includes:

receiving body sensing data of the head of the human body uploaded by a body sensing device; and

determining spatial state information of the head of the human body according to the body sensing data.

The spatial state information of the head of the human body in some embodiments includes azimuth information, speed information and position information of current the head of the human body motion. The system setting parameters of the virtual reality equipment include such parameter information as distance between left and right eyeglasses of the virtual reality equipment, distance between the left and right eyeglasses and a screen, size and specification of the virtual reality equipment and the left and right eyeglasses, etc.

It should be noted that the azimuth information corresponding to the head of the human body may include three-dimensional displacements of head in the space, i.e., front-back displacement, up-down displacement, left-right displacement, or a combination of the displacements, etc.

The body sensing device in some embodiments includes a compass, a gyro, a wireless signal module and at least one sensor and is used for detecting body sensing data of the head of the human body. The sensor is one or more of an acceleration sensor, a direction sensor, a magnetic force sensor, a gravity sensor, a rotating vector sensor and a linear acceleration sensor.

S112: determining a first field angle of the left eye and a second field angle of the right eye of a human body according to the system setting parameters and the spatial state information of the head of the human body.

Particularly, the first field angle of the left eye and the second field angle of the right eye of the human body are determined according to the azimuth information, speed information and position information of the head of the human body motion and in combination with the system setting parameters of the virtual reality equipment.

Further, step S13 of culling a geometry in a 3D scene according to the viewing frustum includes the following steps not shown in the figure:

S131, determining a spatial plane equation corresponding to six planes of the viewing frustum;

S132, deciding the position relation between each point coordinate of the geometry in the 3D scene and each plane according to the spatial plane equation;

S133, determining a culling plane of the viewing frustum according to the position relation; and

S134, culling the viewing frustum according to the culling plane.

In practical application, the spatial plane equation corresponding to six planes of the viewing frustum is calculated, each point coordinate of the geometry in the 3D scene is substituted into the plane equation of the six planes for comparing, and then whether the point is within the viewing frustum or not can be decided.

The specific implementation method for viewing frustum culling in the embodiment of the present disclosure will be described in detail below.

The known spatial plane equation may be expressed as: Ax+By+Cz=0

Correspondingly, for a point (x1, y1, z1):

if Ax1+By1+Cz1=0, the point is on the plane;

if Ax1+By1+Cz1<0, the point is on one side of the plane;

if Ax1+By1+Cz1>0, the point is on the other side of the plane.

The plane coefficient of the viewing frustum is solved first, and then the spatial plane equation corresponding to six planes of the viewing frustum is determined.

The six planes of the viewing frustum are calculated from world, view and project matrixes in this algorithm. This algorithm is quick and convenient, and allows the frustum planes to be quickly determined in the camera space, world space or object space.

From the beginning of the project matrix, it is supposed that both the world and view matrixes are unitized matrixes. This means that the camera is located at the origin of a world coordinate system and faces the positive direction of Z axis.

A vertex v (x y z w=1) and a 4*4 project matrix M=m (i, j) are defined, then the vertex v is converted by using the matrix M, and the converted vertex is v′=(x′ y′ z′ w′). The viewing frustum is actually changed into a box parallel to the axis after conversion. If the vertex v′ is within the box, the vertex v before conversion is within the viewing frustum before conversion. Under the 3D program interface OpenGL, if the following inequations are true, v′ is within the box.

-w′<x′<w′

-w′<y′<w′

-w′<z′<w′

Whether x′ to be tested is within the left half space or not can be decided as

-w<x′

The equation can be written with the above information as:

-(v•row4)<(v•row1)

0<(v•row4)+(v•row1)

0<v•(row4+row1)

The plane equation of the left culling plane of the viewing frustum before conversion is:

x(m41+m11)+y(m42+m12)+z(m43+m13)+w(m44+m14)=0

When W=1, the plane equation of the left culling plane can be simplified in the following form:

x(m41+m11)+y(m42+m12)+z(m43+m13)+(m44+m14)=0

Obtained is a basic plane equation:

ax+by+cz+d=0

Wherein, a=(m41+m11), b=(m42+m12), c=(m43+m13), d=(m44+m14)

i.e., the left culling plane is obtained.

Other culling planes can be derived by repeating the above steps.

Further, the following conclusions can be obtained:

a. If the matrix M is equal to the project matrix P (M=P), the culling plane given by the algorithm is within the camera space.
b. If the matrix M is equal to the combination (M=V*P) of the view matrix V and the project matrix P, the culling plane given by the algorithm is within the world space.
c. If the matrix M is equal to the combination (M=W*V*P) of the world matrix W, the view matrix V and the project matrix P, the culling plane given by the algorithm is within the object space.

Further, the step of deciding whether a node is within the viewing frustum or not is as follows:

solving a similar bounding volume by various bounding volume methods, and deciding the six planes of the viewing frustum via each point on the bounding volume under the following three conditions:

if all vertexes are within the viewing frustum range, the area to be decided must be within the viewing frustum range;

if only a part of the vertexes are within the viewing frustum range, the area to be decided is crossed with the viewing frustum, and the area is regarded as visible similarly; and

if all the vertexes are not within the viewing frustum range, the area to be decided is probably invisible, except one condition that the viewing frustum is within a cuboid, which should be distinguished.

FIG. 2 shows a flow diagram of a display method based on virtual reality equipment according to some embodiments of the present disclosure.

With reference to FIG. 2, the display method based on virtual reality equipment, according to some embodiments of the present disclosure, includes the following steps:

S21, acquiring the geometry culled by the method of viewing frustum culling based on virtual reality equipment in any above embodiment to be presented in the 3D scene;

S22, rendering and drawing the culled geometry to be presented in the 3D scene,

wherein, only the geometry intersected with the real viewing frustum is drawn during rendering and drawing, the culled geometry in the 3D scene is rendered and drawn, and anti-distortion and anti-dispersion processing and display are performed after rendering; and

S23, displaying the rendered and drawn geometry to be presented in the 3D scene.

In the embodiment of the present disclosure, viewing frustum culling is performed on the geometry to be presented in the current 3D scene according to the real viewing frustum determined by the union area of the field angles of human left and right eyes, then the culled geometry to be presented in the 3D scene is rendered and drawn, and the rendered and drawn geometry to be presented in the 3D scene is displayed, so that display of the virtual reality equipment is realized.

According to the display method based on virtual reality equipment in the embodiment of the present disclosure, the viewing frustum of the left and right eyes is uniformly processed and then adopted for viewing frustum culling, so that the data volume for drawing the geometry is greatly reduced, the calculation quantity is reduced, the rendering efficiency is improved, and the rendering delay caused by adopting traditional viewing frustum culling is reduced.

In addition, the above method embodiments are described as a combination of a series of actions for the sake of simplicity, but those skilled in the art should learn that the present disclosure is not limited by the described action sequence; and secondly, those skilled in the art should also learn that the embodiments described in the specification are preferred embodiments, and the involved actions are not always necessary.

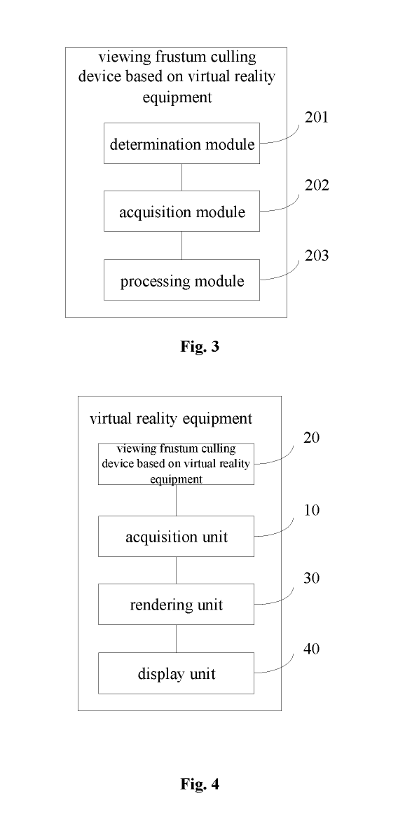

Based on the same inventive concept as the method, the embodiments of the present disclosure further provide a viewing frustum culling device based on virtual reality equipment. FIG. 3 shows a structural schematic diagram of a viewing frustum culling device based on virtual reality equipment according to some embodiments of the present disclosure.

With reference to FIG. 3, the viewing frustum culling device based on virtual reality equipment, according to some embodiments of the present disclosure, includes a determination module 201, an acquisition module 202 and a processing module 203.

The determination module 201 is used for determining a first field angle of the left eye and a second field angle of the right eye of a human body.

In practical application, when the virtual reality equipment is adopted for VR experience, the field angles of human left and right eyes are different, so in order to realize viewing frustum culling of a VR 3D scene, the first field angle of the left eye and the second field angle of the right eye of the human body should be obtained in advance.

It should be noted that the virtual reality equipment in some embodiment is intelligent equipment with a virtual reality function, e.g., a VR helmet, VR glasses, etc., and the present disclosure is not limited thereto.

The acquisition module 202 is used for acquiring a union area of the first field angle and the second field angle as a viewing frustum of the human body.

The acquisition module is used for solving a union from the two field angles of the left and right eyes according to the first field angle of the left eye and the second field angle of the right eye of the human body determined by the determination module 201, wherein the obtained union area is a combined part of visible areas of the left and right eyes, so the obtained union area can be used as a real viewing frustum of the human body.

The processing module 203 is used for culling a geometry to be presented in a current 3D scene according to the viewing frustum.

In this embodiment, the processing module is used for culling the geometry to be presented in the current 3D scene in the virtual reality equipment according to the obtained real viewing frustum of the human body, thus solving the problem of delay caused by two times of culling calculation according to the viewing frustum of the left and right eyes in the viewing frustum culling process of the 3D scene in the prior art, and quickly and conveniently culling the VR 3D scene.

In the embodiment of the present disclosure, the union area of the field angles of human left and right eyes is used as a real viewing frustum of the human body, and viewing frustum culling is performed according to the real viewing frustum, so that the data volume for drawing a geometry is greatly reduced, then the calculation quantity in the viewing frustum culling process is reduced, the rendering efficiency is improved, and the rendering delay caused by adopting traditional viewing frustum culling is reduced.

Further, the determination module 201 includes an acquisition unit and a first determination unit, wherein:

the acquisition unit is used for acquiring spatial state information of the head of the human body and system setting parameters of the current virtual reality equipment; and

the first determination unit is used for determining a first field angle of the left eye and a second field angle of the right eye of a human body according to the system setting parameters and the spatial state information of the head of the human body.

The acquisition unit further includes a receiving subunit and a determination subunit, wherein:

the receiving subunit is used for receiving body sensing data of the head of the human body uploaded by a body sensing device; and

the determination subunit is used for determining spatial state information of the head of the human body according to the body sensing data received by the receiving subunit.

Further, the processing module 203 includes a second determination unit, a decision unit, a third determination unit and a culling unit, wherein:

the second determination unit is used for determining a spatial plane equation corresponding to six planes of the viewing frustum;

the decision unit is used for deciding the position relation between each point coordinate of the geometry in the 3D scene and each plane according to the spatial plane equation;

the third determination unit is used for determining a culling plane of the viewing frustum according to the position relation; and

the culling unit is used for culling the viewing frustum according to the culling plane.

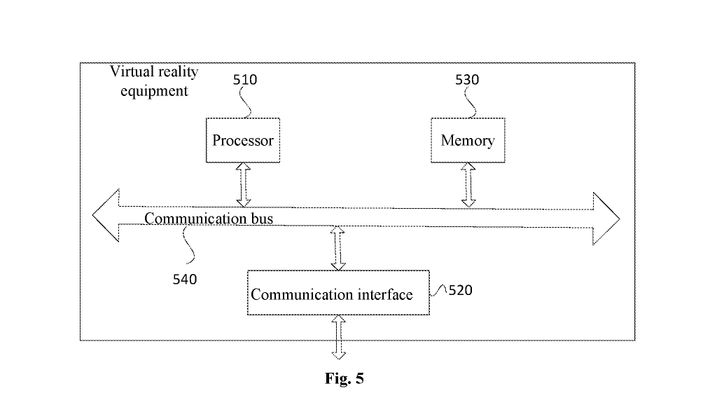

Moreover, the embodiments of the present disclosure further provide virtual reality equipment, as shown in FIG. 4, including: an acquisition unit 10, a rendering unit 30, a display unit 40 and the viewing frustum culling device 20 based on virtual reality equipment in any above embodiment.

The acquisition unit 10 is used for acquiring the geometry culled by the viewing frustum culling device 20 based on virtual reality equipment to be presented in the 3D scene.

The rendering unit 30 is used for rendering and drawing the culled geometry acquired by the acquisition unit 10 to be presented in the 3D scene.

Particularly, the rendering unit 30 only draws the geometry intersected with the real viewing frustum during rendering and drawing and renders and draws the culled geometry in the 3D scene, and anti-distortion and anti-dispersion processing and display are performed after rendering.

The display unit 40 is used for displaying the geometry rendered and drawn by the rendering unit 20 to be presented in the 3D scene.

According to some embodiments of the present disclosure, a viewing frustum culling device based on virtual reality equipment, including: one or more processors; a memory; and one or more modules stored in the memory; the one or more modules are configured to perform the following operations when being executed by the one or more processors: determining a first field angle of the left eye and a second field angle of the right eye of a human body; acquiring a union area of the first field angle and the second field angle as a viewing frustum of the human body; and culling a geometry to be presented in a current 3D scene according to the viewing frustum.

Optionally, the processor is further configured to perform the following steps: acquiring spatial state information of the head of the human body and system setting parameters of the current virtual reality equipment; and determining a first field angle of the left eye and a second field angle of the right eye of a human body according to the system setting parameters and the spatial state information of the head of the human body.

Optionally, the processor is further configured to perform the following steps: receiving body sensing data of the head of the human body uploaded by a body sensing device; and determining spatial state information of the head of the human body according to the body sensing data.

Optionally, the processor is further configured to perform the following steps: determining a spatial plane equation corresponding to six planes of the viewing frustum; deciding the position relation between each point coordinate of the geometry in the 3D scene and each plane according to the spatial plane equation; determining a culling plane of the viewing frustum according to the position relation; and culling the viewing frustum according to the culling plane.

According to some embodiments of the present disclosure, a virtual reality equipment, including a viewing frustum culling device based on virtual reality equipment, the virtual reality equipment including one or more processors; a memory; and one or more modules stored in the memory; the one or more modules are configured to perform the following operations when being executed by the one or more processors: acquiring the geometry culled by the viewing frustum culling device based on virtual reality equipment to be presented in the 3D scene; rendering and drawing the culled geometry acquired by the acquisition unit to be presented in the 3D scene; and displaying the geometry rendered and drawn by the rendering unit to be presented in the 3D scene.

According to the virtual reality equipment according to some embodiments of the present disclosure, the viewing frustum of the left and right eyes is uniformly processed and then adopted for viewing frustum culling, so that the data volume for drawing the geometry is greatly reduced, the calculation quantity is reduced, the rendering efficiency is improved, and the rendering delay caused by adopting traditional viewing frustum culling is reduced.

Particularly, only the geometry intersected with the real viewing frustum is drawn during rendering and drawing, the culled geometry in the 3D scene is rendered and drawn, and anti-distortion and anti-dispersion processing and display are performed after rendering.

The device embodiments are basically similar to the corresponding method embodiments, and are thus described simply. For the relevancy, reference may be made to part of the description of the method embodiments.

In conclusion, according to the viewing frustum culling method and device and the display method based on virtual reality equipment and the virtual reality equipment according to some embodiments of the present disclosure, the union area of the field angles of human left and right eyes is used as a real viewing frustum of the human body, and viewing frustum culling is performed according to the real viewing frustum, so that the data volume for drawing a geometry is greatly reduced, then the calculation quantity in the viewing frustum culling process is reduced, the rendering efficiency is improved, and the rendering delay caused by adopting traditional viewing frustum culling is reduced.

FIG. 5 is a schematic diagram of a solid structure of virtual reality equipment.

Refer to FIG. 5, the virtual reality equipment provided by the embodiment of the present disclosure includes:

a processor 510, a communication interface 520, a memory 530 and a bus 540; wherein,

the processor 510, the communication interface 520 and the memory 530 communicate with each other by the bus 540;

the communication interface 520 is used for completing the information transmission of the virtual reality equipment and a server;

the processor 510 is used for invoking a logic instruction in the memory 540 to execute the following method:

determining a first field angle of the left eye and a second field angle of the right eye of a human body; acquiring a union area of the first field angle and the second field angle as a viewing frustum of the human body; culling a geometry to be presented in a current 3D scene according to the viewing frustum; rendering and drawing the culled geometry to be presented in the 3D scene; and displaying the rendered and drawn geometry to be presented in the 3D scene.

Refer to FIG. 2, the embodiment of the present disclosure further provides a computer program, including a program code, wherein the program code is used for executing the following operations:

determining a first field angle of the left eye and a second field angle of the right eye of a human body;

acquiring a union area of the first field angle and the second field angle as a viewing frustum of the human body; and

culling a geometry to be presented in a current 3D scene according to the viewing frustum.

rendering and drawing the culled geometry to be presented in the 3D scene; and

displaying the rendered and drawn geometry to be presented in the 3D scene.

The embodiment of the present disclosure further provides a storage medium, used for storing the computer program in the foregoing embodiment.

Those of ordinary skill in the art can understand that all or a part of the steps in the above method embodiment can be implemented by a program instructing corresponding hardware, the foregoing program can be stored in a computer readable storage medium, and when being executed, the program can execute the steps including the above method embodiment; and the foregoing storage medium includes various media capable of storing program codes, such as a ROM, a RAM, a magnetic disk or an optical disk, etc.

It should be finally noted that the above embodiments are merely used for illustrating the technical solutions of the present disclosure, rather than limiting the present disclosure; though the present disclosure is illustrated in detail with reference to the aforementioned embodiments, it should be understood by those of ordinary skill in the art that modifications may still be made to the technical solutions disclosed in the aforementioned respective embodiments, or equivalent alterations may be made to a part of or all technical characteristics thereof; and these modifications or alterations do not make the nature of the corresponding technical solutions depart from the scope of the technical solutions of the respective embodiments of the present disclosure.

1. A method of viewing frustum culling based on virtual reality equipment, comprising:
determining a first field angle of the left eye and a second field angle of the right eye of a human body;
acquiring a union area of the first field angle and the second field angle as a viewing frustum of the human body; and
culling a geometry to be presented in a current 3D scene according to the viewing frustum.

2. The method of claim 1, wherein determining a first field angle of the left eye and a second field angle of the right eye of a human body comprises:
acquiring spatial state information of the head of the human body and system setting parameters of the virtual reality equipment; and
determining a first field angle of the left eye and a second field angle of the right eye of the human body according to the system setting parameters and the spatial state information of the head of the human body.

3. The method of claim 2, wherein acquiring spatial state information of the head of the human body comprises:
receiving body sensing data of the head of the human body uploaded by a body sensing device; and
determining spatial state information of the head of the human body according to the body sensing data.

4. The method of claim 1, wherein culling a geometry to be presented in a 3D scene according to the viewing frustum comprises:
determining a spatial plane equation corresponding to six planes of the viewing frustum;
deciding the position relation between each point coordinate of the geometry in the 3D scene and each plane according to the spatial plane equation;
determining a culling plane of the viewing frustum according to the position relation; and
culling the viewing frustum according to the culling plane.

5. A display method based on virtual reality equipment, comprising:
acquiring a geometry culled by the method of viewing frustum culling based on virtual reality equipment in claim 1 to be presented in a 3D scene;
rendering and drawing the culled geometry to be presented in the 3D scene; and
displaying the rendered and drawn geometry to be presented in the 3D scene.

6. A viewing frustum culling device based on virtual reality equipment, comprising:
one or more processors; a memory; and one or more modules stored in the memory, wherein the one or more modules are configured to perform the following operations when being executed by the one or more processors:
a determination module, used for determining a first field angle of the left eye and a second field angle of the right eye of a human body;
an acquisition module, used for acquiring a union area of the first field angle and the second field angle as a viewing frustum of the human body; and
a processing module, used for culling a geometry to be presented in a 3D scene according to the viewing frustum.

7. The device of claim 6, wherein the processor is further configured to perform the following steps:
an acquisition unit, used for acquiring spatial state information of the head of the human body and system setting parameters of the virtual reality equipment; and
a first determination unit, used for determining a first field angle of the left eye and a second field angle of the right eye of a human body according to the system setting parameters and the spatial state information of the head of the human body.

8. The device of claim 7, wherein the processor is further configured to perform the following steps:
a receiving subunit, used for receiving body sensing data of the head of the human body uploaded by a body sensing device; and
a determination subunit, used for determining spatial state information of the head of the human body according to the body sensing data.

9. The device of claim 6, wherein the processor is further configured to perform the following steps:
a second determination unit, used for determining a spatial plane equation corresponding to six planes of the viewing frustum;
a judgment unit, used for deciding the position relation between each point coordinate of the geometry in the 3D scene and each plane according to the spatial plane equation;
a third determination unit, used for determining a culling plane of the viewing frustum according to the position relation; and
culling the viewing frustum according to the culling plane.

10. Virtual reality equipment, comprising the viewing frustum culling device based on virtual reality equipment in claim 6, the virtual reality equipment comprising one or more processors; a memory; and one or more modules stored in the memory, wherein the one or more modules are configured to perform the following operations when being executed by the one or more processors:
the acquisition unit is used for acquiring the geometry culled by the viewing frustum culling device based on virtual reality equipment to be presented in the 3D scene;
the rendering unit is used for rendering and drawing the culled geometry to be presented in the 3D scene; and
the display unit is used for displaying the geometry rendered and drawn to be presented in the 3D scene.

11. (canceled)

12. (canceled)

13. (canceled)
